(19) United States
(12) Patent Application Publication
(10) Pub. No.: US 2017/0068991 A1
(43) Pub. Date: Mar. 9, 2017

(54) METHOD AND SYSTEM FOR PROVIDING TARGETED PROMOTION BASED ON USER PATTERN INFORMATION IN A MOBILE GAME

(71) Applicants: NHN Entertainment Corporation, Seongnam-si (KR); NHN Studio629 Corporation, Seongnam-si (KR)

(72) Inventor: Chuljae Lim, Seongnam-si (KR)

(21) Appl. No.: 15/258,831

(22) Filed: Sep. 7, 2016

(30) Foreign Application Priority Data
Sep. 7, 2015 (KR) 10-2015-0126403

(51) Int. Cl. G06Q 30/02

(52) U.S. Cl. CPC G06Q 30/0267; G06Q 30/0261; G06Q 30/0201; G06Q 30/0209

(57) ABSTRACT

A method of providing a targeted promotion based on user pattern information in a mobile game environment, the method including: storing pattern information associated with an action of a user in response to detecting the action about a product; scoring and statistically analyzing the stored pattern information; periodically transmitting the analyzed pattern information to a server; receiving, from the server, a promotion created based on the pattern information; and displaying the received promotion in association with the product.

### CROSS-REFERENCE TO RELATED APPLICATION

This application claims priority under 35 U.S.C. §119 to Korean Patent Application No. 10-2015-0126403 filed on Sep. 7, 2015, the entire contents of which are incorporated herein by reference.

### BACKGROUND

Field

One or more exemplary embodiments relate to technology for providing a gacha promotion associated with a product in a game environment.

### DESCRIPTION OF RELATED ART

A gacha system refers to a system for drawing a random-box item in which an acquirable item is unclear. The gacha system is also referred to as a random drawing system. In the gacha system, a user is not guaranteed to acquire a desired item every time. For example, when the user purchases an item, the user may acquire an item having a relatively high value per price or an item having a relatively low value per price based on probability. A promotion may refer to a sale promotion provided to the user to boost a user purchase.

Korean Patent Registration No. 10-1325051 discloses a system and method for providing coupons through probability games. However, the related art merely provides a fixed promotion without analyzing user information and thus, the user purchase by the user on an item may not be sufficiently increased.

### SUMMARY

One or more exemplary embodiments provide a method and system for providing a targeted promotion based on user pattern information in a mobile game environment.

According to an aspect of at least one exemplary embodiment, a method of providing a targeted promotion based on user pattern information in a mobile game environment includes: storing pattern information associated with an action of a user in response to detecting the action about a product; scoring and statistically analyzing the stored pattern information; periodically transmitting the analyzed pattern information to a server; receiving, from the server, a promotion created based on the pattern information; and displaying the received promotion in association with the product.

The storing of the pattern information may include storing product information about the product in response to the user purchasing the product a preset number of times or more.

The storing of the pattern information may include storing product information about a product of the user's interest in which the user stopped scrolling and displayed for a preset period of time or more, or extracting an area displaying the product of the user's interest based on a coordinate value corresponding to a location moved by the user; and storing product information about the product included in the extracted area.

The storing of the pattern information may include: displaying a product purchase interface in response to a user selection on the product, and asking the user to confirm a purchase of the product through the product purchase interface; and storing product information about the product in response to the user deciding not to purchase the product through the product purchase interface.

The scoring and the statistically analyzing may include: numerically scoring and accumulating the pattern information; and generating a predicted purchase ranking of the product based on scores of the stored pattern information.

The scoring and the statistically analyzing may include distributing the pattern information to a cloud device based on a preset criterion, and analyzing the distributed pattern information at the cloud device.

The scoring and the statistically analyzing may include: analyzing product information about products owned by the user in a mobile game; and determining which product the user is likely to purchase.

The receiving and the displaying of the promotion may include: receiving, from the server, the promotion created based on the pattern information, and displaying the promotion in association with the product through a promotion interface.

The receiving and the displaying of the promotion may include preferentially displaying the product that corresponds with the promotion created based on the pattern information among a plurality of products.

The receiving and the displaying of the product may include: displaying the promotion created based on the pattern information a preset number of times or more through a separate popup window.

According to an aspect of at least one exemplary embodiment, a method of providing a targeted promotion based on user pattern information in a mobile game environment includes periodically receiving analyzed pattern information from a user terminal; creating a promotion associated with a product in response to the periodically received analyzed pattern information; and providing the promotion associated with the product to the user terminal.

The creating of the promotion may include: creating at least one of promotion selected from a group consisting of; a promotion providing a discount of the product, a buy-one-get-one-free promotion with respect to the product, and a promotion of increased probability for a gacha product of a preset grade or more in response to purchasing the product.

According to an aspect of at least one exemplary embodiment, an apparatus for providing a targeted promotion based on user pattern information in a mobile game environment includes: a storage configured to store pattern information associated with an action from a user in response to detecting the action about a product; an analyzer configured to score and statistically analyze the pattern information in response to storing the pattern information; a transceiver configured to periodically transmit the analyzed pattern information to a server; and receive, from the server, a promotion created based on the pattern information; and a display configured to display the received promotion in association with the product.

The storage may be configured to store product information about the product in response to the user purchasing the product a preset number of times or more.

The storage may be configured to store product information about a product which the user stopped scrolling and displayed for a preset period of time or more; or store product information about the product displayed in an extracted area, the extracted area is determined based on a coordinate value corresponding to a location moved by the user.

The display may be configured to display a product purchase interface in response to a user selection on the product, and ask the user whether to purchase the product through the product purchase interface, and the storage is configured to store product information about the product in response to a user selection on a non-purchase of the product through the product purchase interface.

The analyzer may be configured to numerically score and accumulate the pattern information, and to generate a predicted purchase ranking of the product based on scores of the stored pattern information.

The analyzer may be configured to distribute the pattern information to a cloud device based on a preset criterion, and to analyze the distributed pattern information at the cloud device.

The analyzer may be configured to analyze product information about products owned by the user in a mobile game and to determine a product the user is to purchase.

The display may be configured to receive, from the server, the promotion created based on the pattern information, and to display the promotion in association with the product through a promotion interface.

The display may be configured to preferentially display the product that corresponds with the promotion created based on the pattern information among a plurality of products.

The display may be configured to display the promotion created based on the pattern information a preset number of times or more through a separate popup window.

According to an aspect of at least one exemplary embodiment, a system for providing a targeted promotion based on user pattern information in a mobile game environment includes a receiver configured to periodically receive analyzed pattern information from a user terminal; a creator configured to create a promotion associated with a product in response to the periodically received analyzed pattern information; and a provider configured to provide the promotion associated with the product to the user terminal.

The creator may be configured to create at least one of a promotion selected from a group consisting of; a promotion providing a discount of the product, a buy-one-get-one-free promotion with respect to the product, and a promotion of increased probability for a gacha product of a preset grade or more in response to purchasing the product.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a diagram illustrating an operation of a targeted promotion system according to at least one exemplary embodiment.

FIG. 2 is a block diagram illustrating a configuration of a user terminal and a server according to at least one exemplary embodiment.

FIG. 3 is a block diagram illustrating an example of a processor of a user terminal according to at least one exemplary embodiment;

FIG. 4 is a block diagram illustrating an example of a processor of a server according to at least one exemplary embodiment;

FIGS. 5, 6, and 7 illustrate examples of detecting an action of a user at a user terminal according to at least some exemplary embodiments;

FIGS. 8 and 9 illustrate examples of creating a promotion at a server and displaying the promotion on a user terminal according to at least some exemplary embodiments; and

FIG. 10 is a flowchart illustrating a method performed at a user terminal and a server according to at least one exemplary embodiment.

It should be noted that these figures are intended to illustrate the general characteristics of methods and/or structure utilized in certain exemplary embodiments and to supplement the written description provided below. These drawings are not, however, to scale and may not precisely reflect the precise structural or performance characteristics of any given embodiment, and should not be interpreted as defining or limiting the range of values or properties encompassed by exemplary embodiments.

### DETAILED DESCRIPTION

One or more exemplary embodiments will be described in detail with reference to the accompanying drawings. Exemplary embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some exemplary embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which exemplary embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Exemplary embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more exemplary embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more exemplary embodiments, computer processing devices may be described as including various functional units that perform various operations and/or functions to increase the clarity of the description. However, computer processing devices are not limited to these functional units. For example, in one or more exemplary embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more exemplary embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the exemplary embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the exemplary embodiments, or they may be known devices that are altered and/or modified for the purposes of exemplary embodiments.

A hardware device, such as a computer processing device, may run an operating system (OS) and one or more software applications that run on the OS. The computer processing device also may access, store, manipulate, process, and create data in response to execution of the software. For simplicity, one or more exemplary embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of exemplary embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, exemplary embodiments will be described with reference to the accompanying drawings.

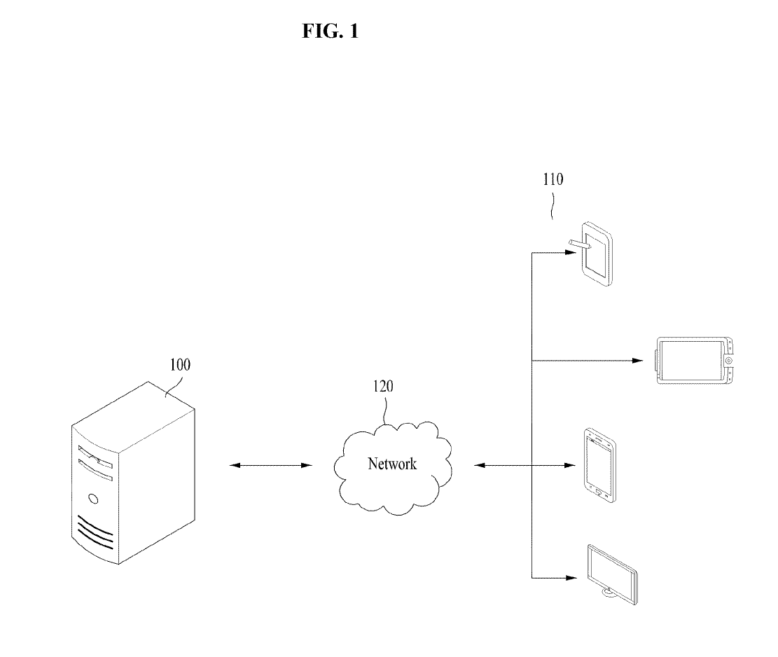

FIG. 1 is a diagram illustrating an operation of a system for providing targeted promotion according to at least one exemplary embodiment.

Referring to FIG. 1, the system for providing targeted promotion in a network environment includes a user terminal 110, a server 100, and a network 120. FIG. 1 only illustrates an exemplary embodiment, and thus, the number of terminals and/or the number of servers are not limited thereto.

The user terminal 110 may be, for example, a smartphone, a mobile phone, navigation, a personal digital assistant (PDA), a portable multimedia player (PMP), a tablet PC, and the like. For example, the user terminal 110 may communicate with other user devices and/or the server 100 over the network 120 in a wired communication environment or in a wireless communication environment.

The network environment is not particularly limited and may include a communication method that uses a near field communication between devices as well as a communication method using a communication network, for example, a mobile communication network, the wired Internet, the wireless Internet, and a broadcasting network. For example, the network 120 may include at least one of network topologies that include networks, for example, a personal area network (PAN), a local area network (LAN), a campus area network (CAN), a metropolitan area network (MAN), a wide area network (WAN), a broadband network (BBN), the Internet, and the like. Also, the network 120 may include at least one of network topologies that include a bus network, a star network, a ring network, a mesh network, a star-bus network, a tree or hierarchical network, and the like. However, it is only an example and the exemplary embodiments are not limited thereto.

The server 100 may be a computer apparatus or a plurality of computer apparatuses configured to provide instructions, codes, files, contents, services, and the like, to the user terminal 110 through communication over the network 120.

For example, the server 100 may provide a file for installing an application to the user terminal 110 over the network 120. The user terminal 110 may install the application using the file provided from the server 100. Also, the user terminal 110 may connect to the server 100 under control of at least one program, for example, browser or the installed application, and an operating system (OS) included in the user terminal 110, and may receive a service or contents provided from the server 100. For example, in response to the user terminal 110 transmitting a service request message to the server 100 over the network 120 under control of the application, the server 100 may transmit a code corresponding to the service request message to the user terminal 110. The user terminal 110 may control and display a screen according to the code under control of the application, thereby providing contents to a user.

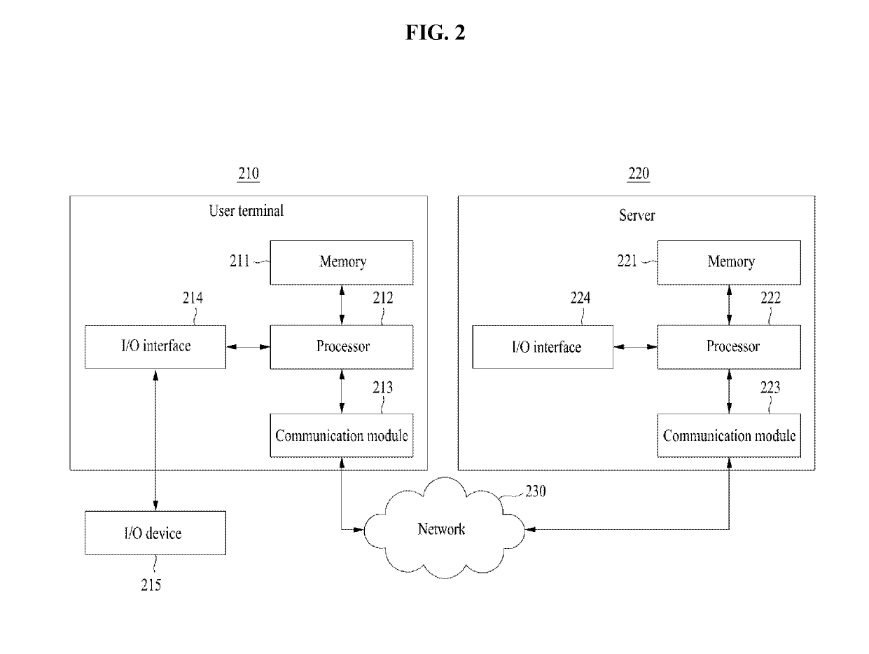

FIG. 2 is a block diagram illustrating an example of a configuration of a user terminal and a server according to at least one exemplary embodiment.

Referring to FIG. 2, the user terminal 210 may include a memory 211, a processor 212, a communication module 213, and an input/output (I/O) interface 214, and the server 220 may include a memory 221, a processor 222, a communication module 223, and an I/O interface 224. The memory 211 and 221 may include a permanent mass storage device, such as random access memory (RAM), read only memory (ROM), a disk drive, etc., as a computer-readable storage medium. Also, an OS and at least one program code, for example, the aforementioned code for browser or the application installed and executed on the user terminal 110, may be stored in the memory 211 and 221. Such software constituent elements may be loaded from another computer-readable storage medium separate from the memory 211 and 221 using a drive mechanism. The other computer-readable storage medium may include, for example, a floppy drive, a disk, a tape, a DVD/CD-ROM drive, a memory card, etc. According to other exemplary embodiments, software constituent elements may be loaded to the memory 211 and 221 through the communication module 213 and 223, instead of, or in addition to, the computer-readable storage medium. For example, at least one program may be loaded to the memory 211 and 221 based on a program, for example, the application, installed by files provided over a network 230 from developers or a file distribution system, for example, the server 100, which provides an installation file of the application.

The processor 212 and 222 may be configured to process computer-readable instructions, for example, the aforementioned at least one program code, of a computer program by performing basic arithmetic operations, logic operations, and I/O operations. The computer-readable instructions may be provided from the memory 211 and 221 and/or the communication module 213 and 223 to the processor 212 and 222. For example, the processor 212 and 222 may be configured to execute received instructions in response to the program code stored in the storage device, such as the memory 211 and 222.

The communication module 213 and 223 may provide a communication between the user terminal 210 and the server 220 over the network 230, and a communication with another electronic device or another server. For example, the processor 212 of the user terminal 210 may transfer a request signal created based on a program code stored in the storage device, such as the memory 211, to the server 220 over the network 230 under control of the communication module 213. Accordingly, a control signal, an instruction, content, a file, etc., provided under control of the processor 222 of the server 220 transmitted via the communication module 223 may be received at the user terminal 210 through the communication module 213 of the user terminal 210 over the network 230. For example, a control signal, an instruction, etc., transmitted by the server 220 and received through the communication module 213 may be transferred to the processor 212 and/or the memory 211, and the user terminal 210 may further include a storage medium to store a content, a file, etc., on the user terminal 210.

The I/O interfaces 214 and 224 may be a device used for interface with an I/O device 215. For example, an input device may include a keyboard, a mouse, etc., and an output device may include a device, such as a display for displaying a communication session of an application. As another example, the I/O interface 214 may be a device for interface with an apparatus in which an input function and an output function are integrated into a single function, such as a touch screen. In detail, when processing instructions of the computer program loaded to the memory 211, the processor 212 of the user terminal 210 may display a service screen configured using data provided from the server 220 or the user terminal 210, or may display content on a display through the I/O interface 214.

According to other exemplary embodiments, the user terminal 210 and the server 220 may include a greater or smaller number of constituent elements than the number of constituent elements shown in FIG. 2. However, there is no need to illustrate many constituent elements according to the related art. For example, the user terminal 210 may include at least a portion of the I/O device 215, or may further include other constituent elements, for example, a transceiver, a global positioning system (GPS) module, a camera, a variety of sensors, a database, and the like.

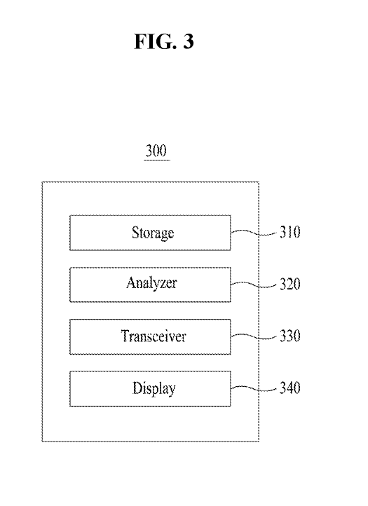

FIG. 3 is a block diagram illustrating an example of a processor of a user terminal according to at least one exemplary embodiment.

Referring to FIG. 3, a processor 300 of a user terminal refers to a device to provide a targeted promotion in a mobile game environment and may include a storage 310, an analyzer 320, a transceiver 330, and a display 340.

The storage 310 may store pattern information associated with an action of a user in response to detecting the action regarding purchasing a product. In response to the user purchasing the product for a preset number of times or more, the storage 310 may store product information about the purchased product. The storage 310 may store product information about a product of the user's interest, such as determined when the user has stopped scrolling and displayed the product for a preset period of time or more. The processor 300 may extract an area displaying the product of the user's interest based on a coordinate value corresponding to a location moved (or scrolled) by the user, and the storage 310 may store the product information about the product displayed in the extracted area. The display 340 may display a product purchase interface in response to a user selection on the product, and may ask the user whether to purchase the product through the product purchase interface, and the storage 310 may also store the product information about the product in response to a user deciding not to purchase the product through the product purchase interface.

The analyzer 320 may score and statistically analyze the pattern information in response to storing the pattern information. The analyzer 320 may numerically score and accumulate the pattern information, and may generate a predicted purchase ranking of the product based on scores of the accumulated pattern information. The analyzer 320 may distribute the pattern information to a cloud device based on a preset criterion, and may analyze the distributed pattern information distributed in the cloud device. The analyzer 320 may analyze the product information about products owned by the user in a mobile game, and may determine which product the user is likely to purchase.

The transceiver 330 may periodically transmit the analyzed pattern information to a server. The transceiver 330 may receive, from the server, a promotion created based on the pattern information, and the display 340 may display the received promotion in association with the product. The transceiver 330 may receive, from the server, the promotion created based on the pattern information, and the display 340 may display the promotion in association with the product through a promotion interface. The display 340 may preferentially display the product that corresponds with the promotion created based on the pattern information among a plurality of products. The display 340 may display the promotion created based on the pattern information a preset number of times or more through a separate popup window.

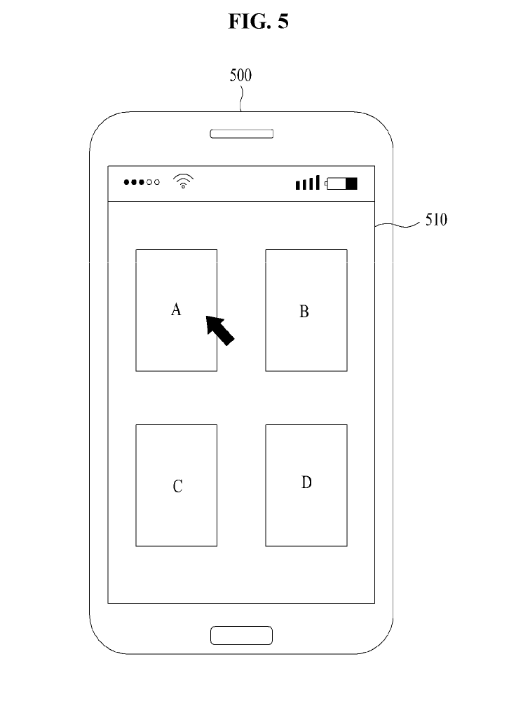

FIGS. 5, 6, and 7 illustrate examples of detecting an action of a user at a user terminal according to at least some exemplary embodiments.

User terminal 500, 600, and 700 include an environment in which mobile game 510, 610, and 710 operates in response to an execution of a mobile game application. A user may purchase a product, for example, an item, avatar, etc., in a game through the user terminal 500, 600, and 700. Here, a game application of the user terminal 500, 600, and 700 may provide a shop in which the user may purchase a product, for example, an item, avatar, etc., in a game environment. The user may purchase a desired product at the shop. The user terminal 500, 600, and 700 may store product information about a product purchased by the user, product information about a product of the user's interest to purchase, and the like. In response to detecting an action of the user about the product, the user terminal 500, 600, and 700 may store pattern information associated with the action.

Referring to FIG. 5, in response to the user purchasing a product a preset number of times, the user terminal 500 may store product information about the purchased product. For example, the user may purchase a preset number or more number of products A during a preset (or predetermined) period of time. For example, if the user terminal 500 determine that the user purchases the same product, for example, the product A more frequently, then the user terminal 500 may store the product information about the product A accordingly.

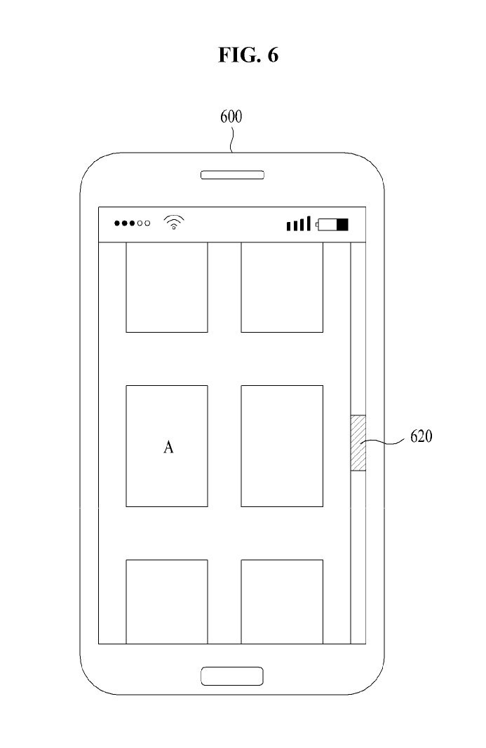

Referring to FIG. 6, the user terminal 600 may store product information about a product of the user's interest in which the user stopped scrolling and displayed for a preset period of time or more. For example, the user may view a plurality of products displayed at a shop. The user may move a scroll bar 620 to search for a product that the user is interested in and/or wants to purchase among the plurality of products displayed at the shop. Here, the user may locate the product that the user is interested or wants to purchase at the middle of a display of the user terminal 600 by moving the scroll bar 620. The user terminal 600 may display the product by scrolling of the user. For example, if the user is interested in the product A, the user may stop scrolling at an area on which the product A is displayed among the plurality of products displayed on the user terminal 600 using the scroll bar 620. The user terminal 600 may store product information about the product A displayed by the scrolling of the user.

Alternatively, the user terminal 600 may extract an area displaying the product of the user's interest based on a coordinate value corresponding to a location moved (or scrolled) by the user, and may store the product information about the product displayed in the extracted area. For example, the user may move the scroll bar 620 to view a product that the user is interested in or is to purchase among the plurality of products displayed at the shop. Here, the user terminal 600 may determine that an area commonly including the product A is displayed by the user for a preset period of time, and may identify the product A from the determined area and may store product information about the product A.

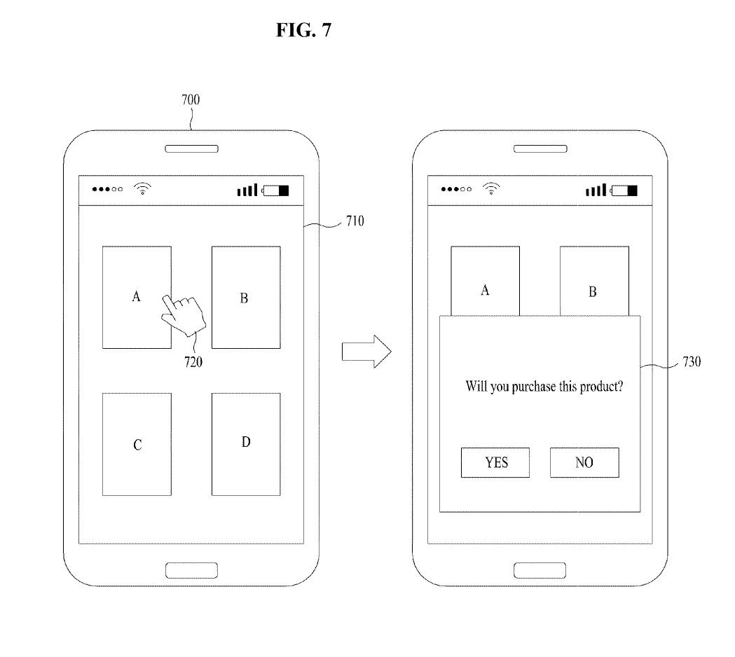

Referring to FIG. 7, the user terminal 700 may display a product purchase interface 730 in response to a selection from a user 720 on a product, and may ask the user 720 to confirm the purchase of the product through the product purchase interface 730. The user terminal 700 may store product information about the product in response to the user 720 deciding not to purchase the product through the product purchase interface 730. For example, the user 720 may first select the product A to purchase the product A among a plurality of products displayed on the user terminal 700. In response to the selection by the user 720 of the product A, the user terminal 700 may output and display a message, such as “will you purchase this product?,” to confirm and proceed with a purchase procedure of the product A. In this instance, if the user 720 decides to purchase the product A, the user 720 may select an interface corresponding to “YES” and may perform a purchase procedure of the product A. On the other hand, if the user 720 decides to suspend the purchase of the product A, due to various reasons, such as price, a necessity for the product, and the like, the user 720 may select an interface corresponding to “NO.” In response to the user 720 suspending the purchase procedure of the product A, the user terminal 700 may store product information about the product A. Since the user 720 may retry to purchase the product A, the user terminal 700 may store information about the product A.

As described above with FIGS. 5, 6, and 7, a user terminal according to at least some exemplary embodiments may store pattern information associated with an action of a user, and may score and statistically analyze the pattern information accordingly. The user terminal may numerically score and accumulate the pattern information, and may generate a predicted purchase ranking of the product based on scores of the accumulated pattern information.

The user terminal may distribute the pattern information to a cloud device based on a preset criterion, and may analyze the distributed pattern information at the cloud device. For example, when analyzing pattern information acquired from the user terminal, the cloud device may analyze the pattern information by classifying the pattern information based on a correlation, such as an age, a region, a time, and the like, or may analyze pattern information included in the same cluster through clustering. For example, the same application may be executed on multiple terminals present in proximity, such as same Internet protocol (IP) zone, and the purchase patterns of each users may be similar. Here, a user terminal may be selected based on a desired (or, alternatively, predetermined) criterion, such as a user terminal that is frequently turned ON, a user terminal that is turned ON long, a user terminal that is initially turned ON, a user terminal that is initially included in an IP zone, and the like. User information of a user terminal adjacent to the selected user terminal may also be received and analyzed. Accordingly, information of users included in the same IP zone as that of the extracted user terminal may be analyzed. Here, personal information may not be included in the user information.

Furthermore, the user terminal may determine product information required for the user by analyzing a product, for example, a character, a card, an item, an avatar, etc., owned by the user. The user terminal may determine product information about a product having a relatively low purchase rate of the user. The user terminal may exclude a product estimated to have been acquired by the user, for example, a product that the user used to frequently purchase, but recently stopped purchasing. The user terminal may periodically transmit the analyzed pattern information to a server.

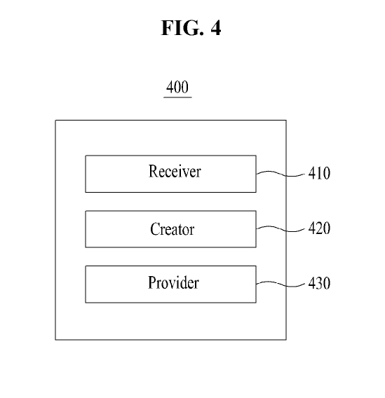

FIG. 4 is a block diagram illustrating an example of a processor of a server according to at least one exemplary embodiment.

Referring to FIG. 4, a processor 400 of a server is configured to provide a targeted promotion, and may include a receiver 410, a creator 420, and a provider 430.

The receiver 410 may periodically receive analyzed pattern information from a user terminal via the communication module of the server.

The creator 420 may create a targeted promotion associated with a product in response to periodically receiving the analyzed pattern information. The creator 420 may create at least one promotion, including a discount of the product, a buy-one-get-one-free promotion with respect to the product, and a promotion of increased probability for a gacha product of a preset grade or more in response to purchasing the product. The buy-one-get-one-free promotion may refer to a promotion of, when the user purchases a product corresponding to the promotion, additional product is offered free of charge.

The provider 430 may provide the promotion associated with the product to the user terminal via the communication module of the server.

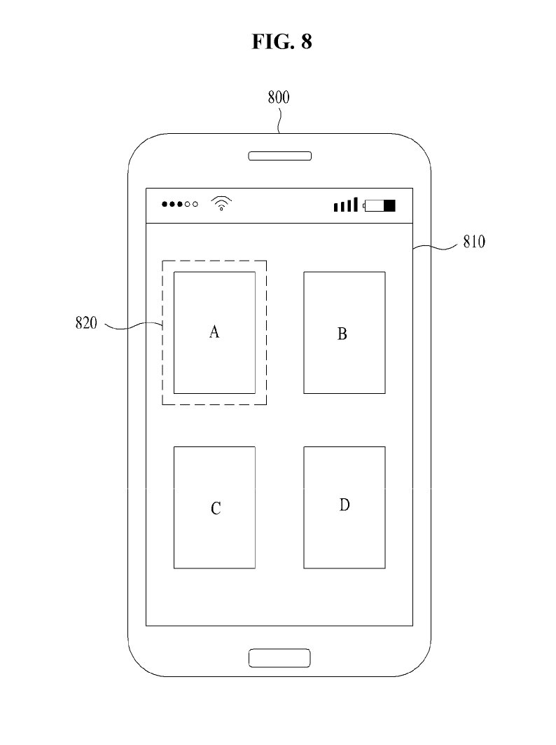

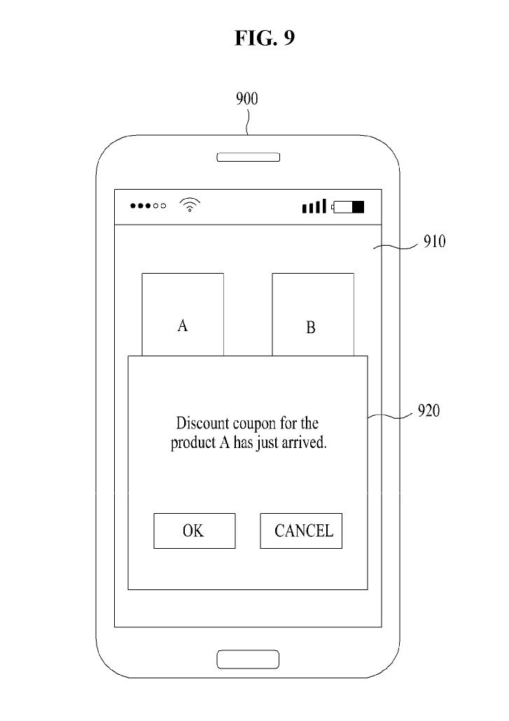

FIGS. 8 and 9 illustrate examples of creating a promotion at a server and displaying the promotion on a user terminal according to at least some exemplary embodiments.

Referring to FIGS. 8 and 9, user terminal 800 and 900 may display a promotion associated with a product through a promotion interface in response to receiving the promotion created based on pattern information from a server. Here, the user terminal 800 and 900 may display a promotion associated with a product in an environment of mobile game 810 and 910. For example, the promotion may include a promotion that provides a discount of the product, a buy-one-get-one-free promotion with respect to the product, and a promotion of increased probability for a gacha product of a preset grade or more in response to purchasing the product, and the like.

Referring to FIG. 8, the user terminal 800 may preferentially display a product that corresponds with a promotion (hereinafter, a product on promotion) among a plurality of products. For example, the user terminal 800 may preferentially display the product on promotion among the plurality of products to be easily recognizable by the user, and may display the product on promotion on a promotion area 820 by providing the promotion area 820 which may separately display a product on promotion.

Referring to FIG. 9, the user terminal 900 may display a product on promotion a preset number of times or more through a separate popup window 920. For example, in response to receiving a promotion about product A from a server, the user terminal 900 may display the promotion associated with the product A through the popup window 920. The user terminal 900 may display a message, such as “discount coupon for the product A has just arrived.” and a message asking whether to accept the coupon for the product A. Also, the user terminal 900 may display a message that provides an additional product with respect to the product A through a promotion interface. Also, the user terminal 900 may provide a message saying that it is possible to increase a probability for a gacha product having a preset grade or more if the user decides to purchase the product A through the promotion interface. Once the user accepts the promotion displayed on the user terminal 900 in the aforementioned manner, the promotion may be applied to the product.

According to the exemplary embodiments, a user terminal may induce the user to purchase a product by displaying a targeted promotion associated with the product for a preset number of times or more during a preset period of time through a promotion interface. Also, according to the exemplary embodiments, a server may increase a product purchase rate of the user by providing a promotion based on pattern information of the user.

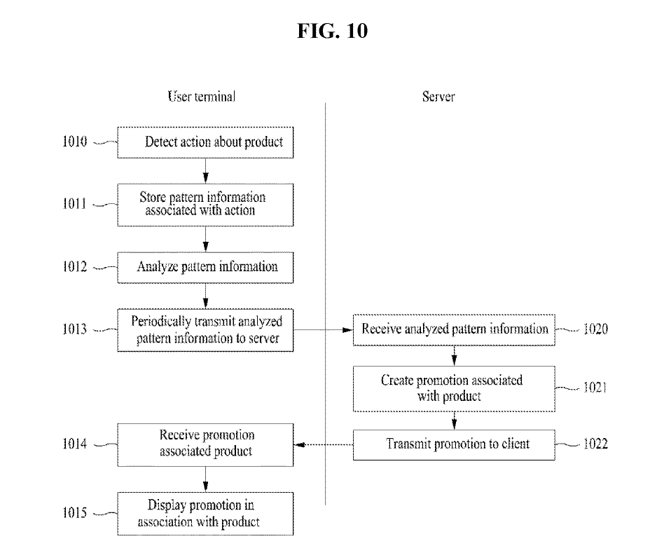

FIG. 10 is a flowchart illustrating a method performed at a user terminal and a server according to at least one exemplary embodiment.

Referring to FIG. 10, the user terminal may be a mobile terminal in which a game application is installed and operated. Herein, the user terminal is assumed to perform the following process through the mobile terminal.

In operation 1010, the user terminal may detect an action of a user about a product. In operation 1011, the user terminal may store pattern information associated with the action in response to the action of the user about the product. In operation 1012, the user terminal may score and statistically analyze the pattern information in response to storing the pattern information. For example, the user terminal may numerically score and accumulate the pattern information, and may generate a predicted purchase ranking of the product based on scores of the accumulated pattern information. Also, the user terminal may analyze product information about products owned by the user in a mobile game and may determine a product the user is to purchase. In operation 1013, the user terminal may periodically transmit the analyzed pattern information to the server.

In operation 1020, the server may periodically receive the analyzed pattern information from the user terminal. In operation 1021, the server may create the promotion associated with the product in response to periodically receiving the analyzed pattern information. For example, the server may create at least one of a promotion including a discount of the product, a buy-one-get-one-free promotion with respect to the product, and a promotion of increased probability for a gacha product of a preset grade or more in response to purchasing the product. In operation 1022, the server may transmit the created promotion to the user terminal.

In operation 1014, the user terminal may receive, from the server, the promotion created based on the pattern information. In operation 1015, the user terminal may display the promotion in association with the product. For example, the user terminal may preferentially display the product that corresponds with the created promotion among a plurality of products, and may display the promotion associated with the product through the promotion interface.

According to at least some exemplary embodiments, since pattern information of a user is analyzed at a user terminal, the system for providing the targeted promotion may have decreased burden on the server and reduced amount of communication packet between the server and the user terminal.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

The foregoing description has been provided for purposes of illustration and description. It is not exhaustive or limited the disclosure. Individual elements or features of a particular exemplary embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are included within the scope of the disclosure.

What is claimed is:

1. A method of providing a targeted promotion based on user pattern information in a mobile game environment, the method comprising:
storing pattern information associated with an action of a user in response to detecting the action about a product;
scoring and statistically analyzing the stored pattern information;
periodically transmitting the analyzed pattern information to a server;
receiving, from the server, a promotion created based on the pattern information; and
displaying the received promotion in association with the product.

2. The method of claim 1, wherein the storing of the pattern information comprises storing product information about the product in response to the user purchasing the product a preset number of times or more.

3. The method of claim 1, wherein the storing of the pattern information comprises:
storing product information about a product of the user's interest in which the user stopped scrolling and displayed for a preset period of time or more, or extracting an area displaying the product of the user's interest based on a coordinate value corresponding to a location moved by the user; and
storing product information about the product included in the extracted area.

4. The method of claim 1, wherein the storing of the pattern information comprises:
displaying a product purchase interface in response to a user selection on the product, and asking the user to confirm a purchase of the product through the product purchase interface; and
storing product information about the product in response to the user deciding not to purchase the product through the product purchase interface.

5. The method of claim 1, wherein the scoring and the statistically analyzing comprises:
numerically scoring and accumulating the pattern information; and
generating a predicted purchase ranking of the product based on scores of the stored pattern information.

6. The method of claim 1, wherein the scoring and the statistically analyzing comprises:
distributing the pattern information to a cloud device based on a preset criterion, and analyzing the distributed pattern information at the cloud device.

7. The method of claim 1, wherein the scoring and the statistically analyzing comprises:
analyzing product information about products owned by the user in a mobile game; and
determining which product the user is likely to purchase.

8. The method of claim 1, wherein the receiving and the displaying of the promotion comprises:
receiving, from the server, the promotion created based on the pattern information, and displaying the promotion in association with the product through a promotion interface.

9. The method of claim 8, wherein the receiving and the displaying of the promotion comprises:
preferentially displaying the product that corresponds with the promotion created based on the pattern information among a plurality of products.

10. The method of claim 8, wherein the receiving and the displaying of the product comprises:
displaying the promotion created based on the pattern information a preset number of times or more through a separate popup window.

11. A method of providing a targeted promotion based on user pattern information in a mobile game environment, the method comprising:
periodically receiving analyzed pattern information from a user terminal;
creating a promotion associated with a product in response to the periodically received analyzed pattern information; and
providing the promotion associated with the product to the user terminal.

12. The method of claim 11, wherein the creating of the promotion comprises:
creating at least one of promotion selected from a group consisting of a promotion providing a discount of the product, a buy-one-get-one-free promotion with respect to the product, and a promotion of increased probability for a gacha product of a preset grade or more in response to purchasing the product.

13. An apparatus for providing a targeted promotion based on user pattern information in a mobile game environment, the apparatus comprising:
a storage configured to store pattern information associated with an action of a user in response to detecting the action about a product;
an analyzer configured to score and statistically analyze the pattern information in response to storing the pattern information;
a transceiver configured to:
periodically transmit the analyzed pattern information to a server; and
receive, from the server, a promotion created based on the pattern information; and
a display configured to display the received promotion in association with the product.

14. The apparatus of claim 13, wherein the storage is configured to store product information about the product in response to the user purchasing the product a preset number of times or more.

15. The apparatus of claim 13, wherein the storage is configured to:
store product information about a product which the user stopped scrolling and displayed for a preset period of time or more; or
store product information about the product displayed in an extracted area, the extracted area is determined based on a coordinate value corresponding to a location moved by the user.

16. The apparatus of claim 13, wherein:
the display is configured to display a product purchase interface in response to a user selection on the product, and ask the user whether to purchase the product through the product purchase interface, and
the storage is configured to store product information about the product in response to a user selection on a non-purchase of the product through the product purchase interface.

17. The apparatus of claim 13, wherein the analyzer is configured to numerically score and accumulate the pattern information, and to generate a predicted purchase ranking of the product based on scores of the stored pattern information.

18. The apparatus of claim 13, wherein the analyzer is configured to distribute the pattern information to a cloud device based on a preset criterion, and to analyze the distributed pattern information at the cloud device.

19. The apparatus of claim 13, wherein the analyzer is configured to analyze product information about products owned by the user in a mobile game, and to determine a product the user is to purchase.

20. The apparatus of claim 13, wherein the display is configured to receive, from the server, the promotion created based on the pattern information, and to display the promotion in association with the product through a promotion interface.

21. The apparatus of claim 20, wherein the display is configured to preferentially display the product that corresponds with the promotion created based on the pattern information among a plurality of products.

22. The apparatus of claim 20, wherein the display is configured to display the promotion created based on the pattern information a preset number of times or more through a separate popup window.

23. A system for providing a targeted promotion based on user pattern information in a mobile game environment, the system comprising:
a receiver configured to periodically receive analyzed pattern information from a user terminal;
a creator configured to create a promotion associated with a product in response to the periodically received analyzed pattern information; and
a provider configured to provide the promotion associated with the product to the user terminal.

24. The system of claim 23, wherein the creator is configured to create at least one of a promotion selected from a group consisting of; a promotion providing a discount of the product, a buy-one-get-one-free promotion with respect to the product, and a promotion of increased probability for a gacha product of a preset grade or more in response to purchasing the product.
